(19) United States
(12) Patent Application Publication
(10) Pub. No.: US 2017/0225413 A1
(43) Pub. Date: Aug. 10, 2017

(54) METHOD FOR MANUFACTURING A REINFORCED PART COMPRISING A COMPOSITE MATERIAL

(71) Applicant: DEDIENNE MULTIPLASTURGY GROUP, Saint Aubin Sur Gaillon (FR)

(72) Inventors: Frédéric LARROUY, Paris (FR); Pierre-Jean LEDUC, Ande (FR); Fabrice DUPAS, La Croix Saint Leufroy (FR)

(73) Assignee: DEDIENNE MULTIPLASTURGY GROUP, Saint Aubin Sur Gaillon (FR)

(21) Appl. No.: 15/501,983

(22) PCT Filed: Jul. 30, 2015
(86) PCT No.: PCT/EP2015/067488

§ 371 Date: Feb. 6, 2017

(30) Foreign Application Priority Data
Aug. 4, 2014 (FR) 14 57574

(51) Int. Cl. B29C 70/68; B29C 70/38; B29C 45/14

(52) U.S. Cl. CPC B29C 70/68; B29C 45/14786; B29C 70/38; B29K 2105/0881

(57) ABSTRACT

Method for manufacturing a reinforced part, including the steps of: producing a support structure and then covering the support structure, at least partially, with at least one composite material including reinforcement fibres, with local adhesion of the support structure and/or the composite material, during positioning thereof, to ensure its retention on the support structure, the support structure being an integral part of the reinforcing part.

The present invention relates to processes for manufacturing reinforced components comprising a composite material and also to the reinforced components thus manufactured.

It is known to mechanically reinforce certain components made of thermoplastic or thermosetting material by means of the presence within them of a composite material comprising reinforcing fibers, for example carbon fibers.

In the case of certain functional components, the composite material may locally resemble a plate that is composed of strata stacked on top of one another and compressed in order to obtain a macroscopically homogenous structure. Each stratum in fact consists of fibers, the voids between which are filled by a polymer matrix.

The shape given to the composite material, in particular its profile and the orientation of the reinforcing fibers, is chosen so that the forces are as much as possible transmitted along the fibers.

Various technologies exist for shaping composite materials.

In particular there is stamping, thermocompression, resin transfer molding (RTM and variants thereof), inter alia.

Generally, the shaping technologies are divided into two distinct groups: those that involve positioning of the fibers followed by filling with a thermoplastic or with a thermoset and those that relate to the shaping of fibers already impregnated with resin.

In the case of positioning reinforcing fibers followed by filling, the current processes require highly fluid resins in order to cover the fibers while penetrating to the core of the mesh that they form; the corresponding production times are generally long.

In the case of shaping fibers already impregnated with resin, a composite material framework is obtained that does not make it possible to easily produce complex shapes. This framework may subsequently either be assembled to other composite material reinforcements by welding, thermocompression, adhesive bonding or riveting, or be overmolded by a skin made of thermoplastic or thermosetting material. In the latter case, the composite material framework acts as an insert which needs to be positioned in a mold, where it is subjected to the injection pressure with a risk of deformation.

Publication WO 2014/058884 discloses an improvement to processes of this type, in which a composite material ply is shaped, then a reinforcement is overmolded around this ply that is intended to maintain the desired shape thereof for the subsequent transformation operations. Next, a plastic shell is overmolded around the composite material ply and its reinforcement in order to give the reinforced component its final shape. In such a process, the composite material ply is shaped by a conventional process, which introduces constraints as regards the shape that can be given to the ply, as indicated above.

Application FR 2 998 838 relates to a seat reinforcement and its manufacturing process. The process described stops at the lay-up of the composite, limiting the shapes and the functions of the component.

Application DE 10201300737 5A1 describes a motor vehicle chassis structure comprising two outer skins made of composite, which may be laid up on a metal structure.

The invention aims to further improve the processes for manufacturing reinforced components, in particular to overcome all or some of the above drawbacks, and it achieves this by means of a process for manufacturing a reinforced component, comprising the steps consisting in:

a) producing a support structure, in particular at least partially made of thermoplastic or thermosetting material, preferably made of thermoplastic material, then

b) covering this support structure at least partially with at least one composite material comprising reinforcing fibers, with a local adhesion of the support structure and/or of the composite material during the lay-up thereof, in particular by melting, in order to ensure the hold thereof on the support structure, the latter being an integral part of the reinforced component thus produced.

The final reinforced component preferably constitutes a rigid structure.

The invention offers many advantages.

Firstly, the invention offers increased options as regards the shape that may be given to the composite material, since the latter may be positioned gradually on the support structure, for example by being laid up layer by layer at the desired locations; the layering may make it possible to locally obtain different thicknesses on the composite framework.

The invention also allows easy handling of the component coated with the composite material for optional subsequent transformation operations.

In particular, deformation of the composite material need no longer be feared during the treatment of the assembly constituted by the support structure coated with the composite material in order to overmold a shell thereon.

The invention makes it possible to more easily orient the reinforcing fibers in the desired direction.

The invention additionally permits medium-volume and mass production owing to the fact that the handling operations are facilitated, makes it possible to save on one or more specific tools and also on certain handling operations of the composite component and to reduce losses due to scrap resulting from semi-finished products.

Preferably, the process comprises step c) according to which the composite material is covered at least partially with a shell of a thermoplastic or thermosetting plastic material, the shell being advantageously injection overmolded onto the composite material.

The presence of the shell makes it possible to add shapes to the component, depending on the requirements, and furthermore protects the fibers of the composite material from contact with the final user or from contact with fluids.

In particular when the shell is injection overmolded, the presence of the support structure (also referred to as primary component) helps to maintain the layer of composite material (also referred to as composite core) and prevents the deformation thereof under the effect of the injection pressure. A better control of the overmolded thicknesses and of the geometry of the final component is obtained. This may also offer the possibility of covering the core with the shell at any point, if necessary.

Where appropriate, the steps b) and c) are repeated, the composite materials of the various steps b) that are repeated being identical or different, the materials of the shells of the steps c) that are repeated being identical or different.

The support structure is preferably non-metallic, in particular being made of plastic material.

The invention may also have all or some of the following advantageous characteristics, considered alone or in combination:

the shell completely covers the support structure and the composite material,

the shell completely covers the support structure without completely covering the composite material,

the process completely covers the composite material without completely covering the support structure,

the composite material is laid up in the form of at least one tape, in particular of unidirectional fibers, which is unwound as it is laid on the support structure,

the composite material is laid up by a robotic arm equipped with a tool for heating the surface of the support structure and/or of the composite material,

the reinforcing fibers of the composite material are carbon fibers,

the general shape of the reinforced component is given by the shape of the support structure,

the volume of the support structure corresponds to more than 50%, better still to more than 95%, of the volume of the reinforced component,

the support structure comprises, in particular consists of, a thermoplastic material,

the composite material comprises one or more layers of unidirectional fibers as a tape,

the composite material comprises, in particular consists of, a thermoplastic prepreg.

The invention may make it possible to produce, if desired, a completely non-metallic component.

Another subject of the invention is a reinforced component, in particular obtained by the process according to the invention as defined above, comprising:

a support structure, preferably made of thermoplastic or thermosetting material, that is an integral part of the reinforced component,

a composite material comprising reinforcing fibers that at least partially covers the reinforcing structure, the composite material preferably comprising a thermoplastic polymer matrix,

a shell that at least partially, preferably completely, covers the composite material.

The component may comprise one or more layers of composite material externally covering the shell.

Each layer of composite material may be at least partially covered by a shell.

The invention may be better understood on reading the detailed description which follows of nonlimiting exemplary embodiments thereof, and on examining the appended drawings, in which:

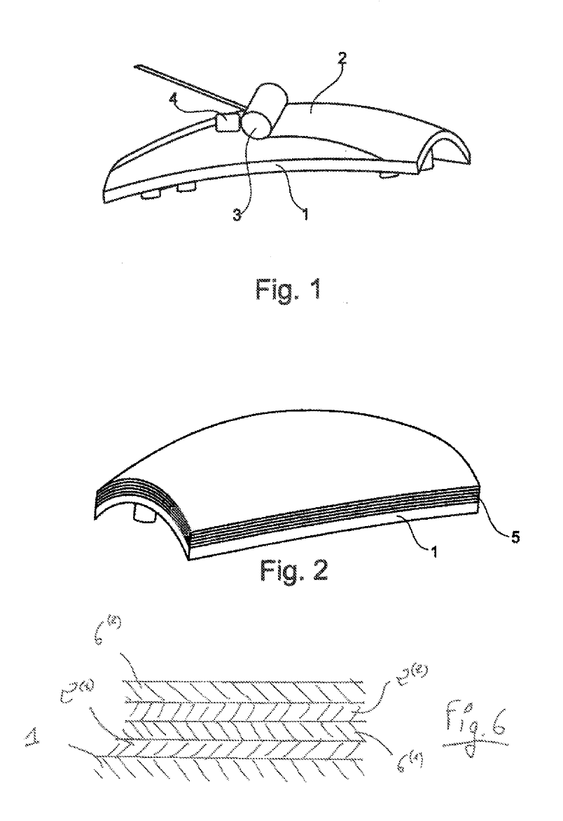

FIGS. 1 to 3 illustrate various steps of an example of a manufacturing process according to the invention,

FIGS. 4 and 5 represent a variant of the reinforced component according to the invention, and

FIG. 6 schematically illustrates another variant.

### Support Structure

The process according to the invention involves the prior production of a support structure.

This support structure is an integral part, in accordance with the invention, of the final reinforced component.

The support structure may be independent of any more general assembly, or as a variant belong to a more general assembly.

For example, the support structure is intended to be completely covered by the composite material. As a variant, the support structure is only one part of a larger-sized assembly and the composite material is only laid up on a portion of this larger-sized assembly.

The support structure is preferably made of plastic, which may be a thermoplastic or thermosetting material, preferably a thermoplastic material.

It is however advantageous for the support structure to be at least partially made of thermoplastic material, so as to be able to melt locally during the lay-up of the composite material, which may improve the hold thereof.

As a variant, the support structure is at least partially made of metal or of ceramic, and in particular it may be a metal/plastic hybrid, metal/thermoplastic hybrid and preferably composite/thermoplastic hybrid. The support structure may be given the desired shape by machining, and by injection molding of material, 3D printing, rotomolding, or any other manufacturing process.

Among the materials that may go into the manufacture of the support structure, mention may be may, for example, of PEEK, PPS, PEI, PA-11, PA-6.6, it being possible for these materials to be optionally reinforced by fibers, in particular glass fibers, natural fibers or carbon fibers.

The support structure is produced with a shape which is preferably close to that of the final reinforced component. Thus, the support structure may occupy a not insignificant portion of the volume of the final reinforced component, in particular more than 50%, or even more than 90% or 95%. The volume of the support structure is that defined by the envelope of its outer surface. Thus, if the support structure is tubular, only the external volume is considered, as if the support structure was solid. The same applies for determining the volume occupied by the final reinforced component.

The support structure may be solid or hollow, and in particular may comprise reinforcing ribs or partitions.

At at least one location, the support structure has for example a thickness of at least 1 mm.

### Lay-Up of the Composite Material

The process according to the invention involves a step of covering the support structure, at least partially, with a composite material that is flexible at the time it is laid up.

The composite material comprises reinforcing fibers and a polymer matrix.

### Reinforcing Fibers

The reinforcing fibers may be of any type, and in particular may be natural or synthetic, mineral or organic, carbon, graphite, glass, aramid, silicon carbide, flax or hemp fibers.

The fibers are preferably oriented long fibers.

The expression “long fibers” denotes continuous fibers, that is to say fibers ranging from one end to the other of the structure that they produce.

The cross section of the fibers ranges for example from 0.03 mm to 0.5 mm.

The thickness of a layer of reinforcing fibers laid up ranges for example from 0.1 mm to 0.5 mm, it being possible for the stack of layers to range from 0.1 mm to more than 10 mm.

The reinforcing fibers are preferably, at the moment when they are laid up on the support structure, in the form of semi-finished products such as plies or mats, which may be unidirectional or multidirectional, these plies or mats for example being supplied as rolls to a lay-up tool.

The reinforcing fibers may also be in the form of yarns comprising fibers braided together, of braids comprising several yarns or of 2D or 3D woven or knitted fabrics manufactured using these yarns.

### Matrix

The composite material preferably constitutes a prepreg, i.e. the fibers are already covered with an organic semi-solid matrix when they are laid up on the support structure.

The matrix may be thermoplastic or thermosetting, preferably thermoplastic.

As a variant, the composite material is a co-mingled material, i.e. a bundle of reinforcing fibers mixed with thermoplastic fibers before the shaping thereof by weaving or braiding in particular.

As matrix, use may be made of a polyolefin, in particular polypropylene, polyamide, in particular PA-6 and PA-11, polyester, PVC, ABS, PBT, PLA, PEEK, PEI or PPS.

The composite material is preferably a unidirectional prepreg, that is to say with reinforcing fibers oriented in one and the same direction within the composite material.

As examples of commercial references of composite materials that may be suitable for the invention, mention may be made, inter alia, of those known under the commercial references TENCATE, TOHO TENAX and SCHAPPE TECHNIQUES.

### Lay-Up Process

The composite material is laid up on the support structure using any suitable means.

Preferably this lay-up is gradual, that is to say that the support structure is gradually covered by the composite material and the latter is attached to the support structure as it is brought into contact with the support structure.

The composite material may be on a roll or on a spool which is gradually unwound onto the support structure, following a path that corresponds to the orientation and the shape that it is desired to give to the reinforcing fibers.

The composite material may be laid up as a single layer, or preferably as several layers that are superposed, in particular directly on one another.

The lay-up means is for example a robotic arm which applies the composite material against the support structure as it is unwound.

Heating is carried out locally in order to attach the composite material to the support structure or to an underlying layer of the composite material. This heating is sufficiently localized so that the support structure retains its shape by itself, remaining at sufficiently low temperature otherwise. The heating for example brings the surface temperature of the composite material or of the support structure to a temperature close to the melting temperature of the matrix, this temperature being selected as a function of the materials to be assembled.

Preferably, the composite material is a prepreg, so that the heating thereof makes it possible to make it adhere to the support structure after cooling, owing to the local melting of the thermoplastic matrix that it comprises.

The support structure may also soften and help to hold the composite material by local melting then solidification of the material that constitutes it.

Preferably, the composite material is a prepreg with a thermoplastic matrix and the support structure is also made of thermoplastic material.

The heating may be radiative heating and/or hot-air heating, ultrasonic heating or radiofrequency heating. A laser or a plasma torch may be used.

Preferably, the tool that lays up the composite material makes it possible to produce the supply of heat needed to ensure the local adhesion and the attachment of the composite material.

The composite material is thus laid up for example using a robotic arm that makes it possible not only to apply the composite material as it is unwound, but also to heat it.

The lay-up tool may apply a local pressure to the composite material in order to press it against the support structure.

The lay-up operation may take place under an inert gas, the latter being used where appropriate, by being hot, to bring about the desired local melting.

It may be advantageous to ensure that, during the lay-up of the composite material, the polymer material thereof fuses with the polymer material of the support structure. Thus an increased cohesion between the primary component and the composite core is obtained.

### Shell

The process according to the invention may also involve covering the composite material with a shell.

The shell is preferably made of thermoplastic or thermosetting plastic material.

The shell may be made of polycarbonate, polyphenylene sulphide, polyetherimide, polyetherketone (PEEK), PPS, PEI, PA-11, PA-6, ABS, and preferably made of a material having thermal characteristics similar to those of the support structure or of the composite matrix.

Preferably, the shell is injection overmolded onto the composite material or the composite material and the support structure.

The shell may also be laid up by 3D printing, injection molding, adhesive bonding or mechanical assembly.

Before producing the shell, the assembly consisting of the support structure coated with the composite material may undergo various mechanical transformation treatments such as machining, drilling, tapping, trimming or placement of mechanical elements such as inserts.

In particular, it is possible, before the step of overmolding the shell, to put in place one or more inserts for example.

The shell may also consist of a metal skin that is bonded to the composite material, for example a titanium foil or a foil of another metal.

The shell may be made from a material of a type identical to or different from that of the support structure.

Recesses, through-recesses or blind recesses, or projecting reliefs may be present in or on the support structure and/or the composite material to enable the shell to grip the support structure more, in order to increase the attachment of this shell to the support structure.

The shell may be laid up in the mold where the assembly consisting of the support structure and of the composite material attached on top is placed. As a variant, the shell is laid up by spraying.

At at least one location, the shell has for example a thickness of at least 1 mm.

### Applications

The invention applies to the production of any component that must include a composite material, in particular for weight or structural strength reasons.

The invention applies to the production of any component requiring a composite material, the production of which requires medium to high rates of output while allowing great geometric variability regarding the shape of the composite framework both in the thicknesses and in the arrangement of the fibers, while avoiding the hazardous operations of removing the composite component from a specific tool.

It may be an aeronautic or automotive component, for example a seat leg, a transmission cam, or friction ailerons.

### Examples

A first exemplary embodiment of a reinforced component according to the invention will now be described with reference to FIGS. 1 to 3.

Represented in FIG. 1 is an example of a support structure 1, produced with a shape close to that of the final reinforced component, and in particular with a shape which has the same general curvature and the same spatial extensions as the final component.

The support structure 1 is for example made from thermoplastic material by injection molding.

Illustrated in FIG. 1 is the lay-up of the composite material 2 in the form of a unidirectional prepreg tape applied directly to the support structure 1 using a fiber-placement machine, represented schematically by a roller 3 and a heating device 4 which may be a laser beam, an infrared lamp or any other suitable device for locally melting the polymer matrix of the composite material and the material of the support structure 1.

The first layer of composite material 2 that is laid up is thus welded directly to the support structure 1 by the fiber-placement machine. In the example illustrated, only the top of the support structure 1 is thus covered.

It is possible to lay up several layers of composite material one on top of the other and FIG. 2 illustrates a stack 5 of composite material plies thus produced using the equipment from FIG. 1.

The number of plies and the arrangement thereof are selected as a function of the mechanical characteristics desired for the final component.

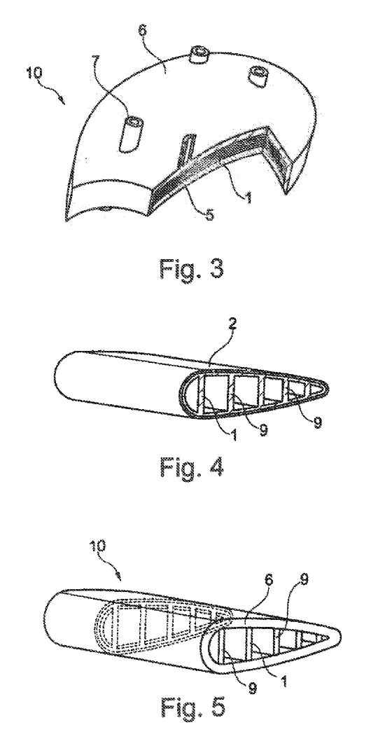

In FIG. 3, the assembly obtained above is overmolded by a shell 6 in order to complete it.

Before overmolding of the shell 6, the assembly from FIG. 2 may optionally undergo an intermediate transformation such as machining.

It is also possible, before overmolding of the shell 6, to lay up material on the assembly by 3D printing.

In the example from FIG. 3, the overmolding corresponds to a sheathing of the composite material, the shell 6 covering the composite material not only on top but also over its edge. The shell 6 does not cover the lower face of the support structure 1.

The shell 6 may be produced, as illustrated, with functional reliefs 7, for example shafts intended to receive screws.

It is seen in FIG. 3 that the support structure 1 is an integral part of the final reinforced component 10.

Represented in FIG. 4 is a support structure 1 that is in the form of a tube that is injection molded, machined or produced by a prototyping technique such as 3D printing.

The composite material 2 is laid up over the whole of the circumference of the tube, for example by being wound around the support structure.

The composite material 2 is for example in the form of a unidirectional prepreg tape.

Illustrated in FIG. 5 is the possibility of overmolding the assembly from FIG. 4 with a shell 6 which sheathes the component, covering the composite material over its outer surface and over its edge.

It is seen that the shell 6 also covers the inner surface of the tube apart from the partitions 9 and does not completely fill the internal volume defined between the partitions 9.

It is seen in FIGS. 4 and 5 that the support structure 1 has, in cross section, an aircraft wing profile which is retained in the final reinforced component 10.

Of course, the invention is not limited to the examples which have just been described.

The support structure may be produced in yet another way and may for example comprise a portion which does not receive the composite material nor the optional shell. The reinforcement by the composite material may thus be only local.

It is also possible, as illustrated in FIG. 6, to produce several composite materials/shell superpositions, for example as illustrated by the following stack: support structure/composite material 2⁽¹⁾/shell 6⁽¹⁾/composite material 2⁽²⁾/shell 6⁽²⁾).

Even more superpositions may be provided, if necessary.

The materials of the shells 6⁽¹⁾, . . . 6⁽ⁱ⁾ with i≧2 may be identical or different, likewise for the composite materials 2⁽¹⁾, . . . 2⁽ⁱ⁾.

In other words, a component comprising the support structure, the composite core and the shell may be considered to be a primary component for novel steps of laying up a composite material and a shell.

The expression “comprising a” should be understood as being synonymous with “comprising at least one”, unless otherwise specified.

1-18. (canceled)

19. A process for manufacturing a reinforced component, comprising:
a) producing a support structure,
b) covering this support structure at least partially with at least one composite material comprising reinforcing fibers, with a local adhesion of the support structure and/or of the composite material during the lay-up thereof, in order to ensure the hold thereof on the support structure, the latter being an integral part of the reinforced component, and then
c) covering the composite material at least partially with a shell of a thermoplastic or thermosetting plastic material.

20. The process as claimed in claim 19, the shell being injection overmolded onto the composite material.

21. The process as claimed in claim 19, the shell completely covering the support structure and the composite material.

22. The process as claimed in claim 19, the shell completely covering the support structure without completely covering the composite material.

23. The process as claimed in claim 19, the shell completely covering the composite material without completely covering the support structure.

24. The process as claimed in claim 19, the composite material being laid up in the form of at least one tape, which is unwound as it is laid on the support structure.

25. The process of claim 24, the tape being made of unidirectional fibers.

26. The process as claimed in claim 24, the composite material being laid up by a robotic arm equipped with a tool for heating the surface of the support structure and/or of the composite material.

27. The process as claimed in claim 19, the reinforcing fibers of the composite material being carbon fibers.

28. The process as claimed in claim 19, the general shape of the reinforced component being given by the shape of the support structure.

29. The process as claimed in claim 19, the volume of the support structure corresponding to more than 50% of the volume of the reinforced component.

30. The process of claim 29, the volume of the support structure corresponding to more than 95% of the volume of the reinforced component.

31. The process as claimed in claim 19, the support structure comprising a thermoplastic material.

32. The process as claimed in claim 19, the composite material comprising one or more layers of unidirectional fibers as a tape.

33. The process as claimed in claim 19, the composite material comprising a thermoplastic prepreg.

34. The process as claimed in claim 19, the steps b) and c) being repeated, the composite materials of the various steps b) that are repeated being identical or different, the materials of the shells of the steps c) that are repeated being identical or different.

35. The process as claimed in claim 19, the support structure being non-metallic.

36. The process of claim 35, the support structure being made of plastic material.

37. A reinforced component comprising:
a support structure that is an integral part of the reinforced component,
a composite material comprising reinforcing fibers that at least partially covers the reinforcing structure, the composite material comprising a thermoplastic polymer matrix,
a shell that at least partially covers the composite material.

38. The component as claimed in claim 37, comprising one or more layers of composite material externally covering the shell.

39. The component as claimed in claim 37, each layer of composite material being at least partially covered by a shell.
